(19) United States
(12) Patent Application Publication
(10) Pub. No.: US 2023/0287917 A1
(43) Pub. Date: Sep. 14, 2023

(54) SYSTEM WITH VERTICALLY ADJUSTABLE TELESCOPING POLE ASSEMBLY AND CRAMP BRAKE MECHANISM

(71) Applicant: Grovist Innovations LLC, Depoe Bay, OR (US)

(72) Inventor: Vince OVIST, Depoe Bay, OR (US)

(21) Appl. No.: 18/050,923

(22) Filed: Oct. 28, 2022

Related U.S. Application Data
(63) Continuation of application No. 16/898,325, filed on Jun. 10, 2020, now abandoned.
(60) Provisional application No. 62/859,618, filed on Jun. 10, 2019.

(51) Int. Cl. F16B 7/10; F16D 63/00

(52) U.S. Cl. CPC F16B 7/105; F16D 63/008; F16D 2121/16

(57) ABSTRACT

A system with a vertically adjustable telescoping pole assembly and cramp brake mechanism includes a telescoping pole assembly with at least an outer pole and an inner pole. The pole assembly is movable bi-directionally between a closed position and an extended position. The cramp brake mechanism has a body that is secured to the outer pole of the pole assembly, and also includes a brake that releases while the pole assembly is moved to the extended position and engages when the assembly is not being moved.

### CROSS-REFERENCE TO RELATED APPLICATIONS

This application is a continuation of U.S. patent application Ser. No. 16/898,325, filed Jun. 10, 2020, which application claims priority to U.S. Provisional Patent Application Ser. No. 62/859,618, filed Jun. 10, 2019, the disclosures of which are incorporated herein by reference.

### FIELD

Conventional cramping brakes for telescoping tubes have undesirable pinch points and require users to stand on ladders to extend and lock the tubes. The purpose of this invention is to eliminate pinch points associated with legacy locking mechanisms, and to provide users with a smooth non-marring lock. In operation, when the poles of the system of the invention are extended, the brake mechanism slips in the direction of extension. When in a rest position the system is locked, and to initiate a collapse operation, the system requires minimal effort from the user. The system of the invention can be used for any application that requires an upright pole, such as for constructing a trade show booth.

### BRIEF DESCRIPTION OF THE DRAWINGS

FIG. 1 shows an isometric view and two side views of the components of the system of the invention.

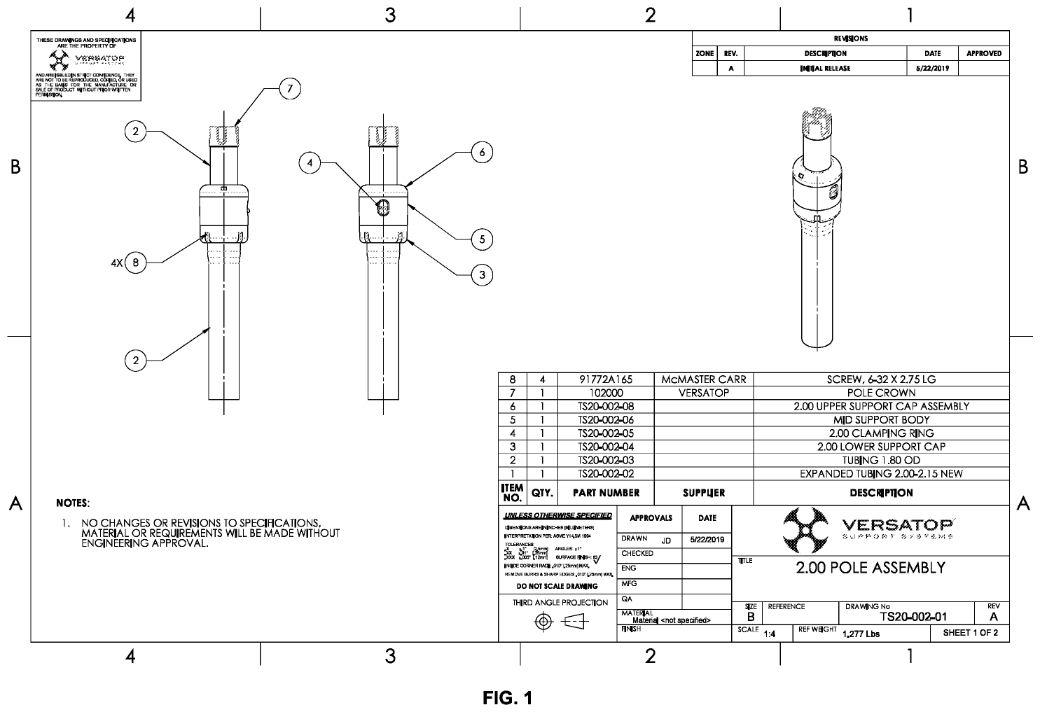

FIG. 2 shows two sectional views and one side view of the pole assembly of the system of the invention.

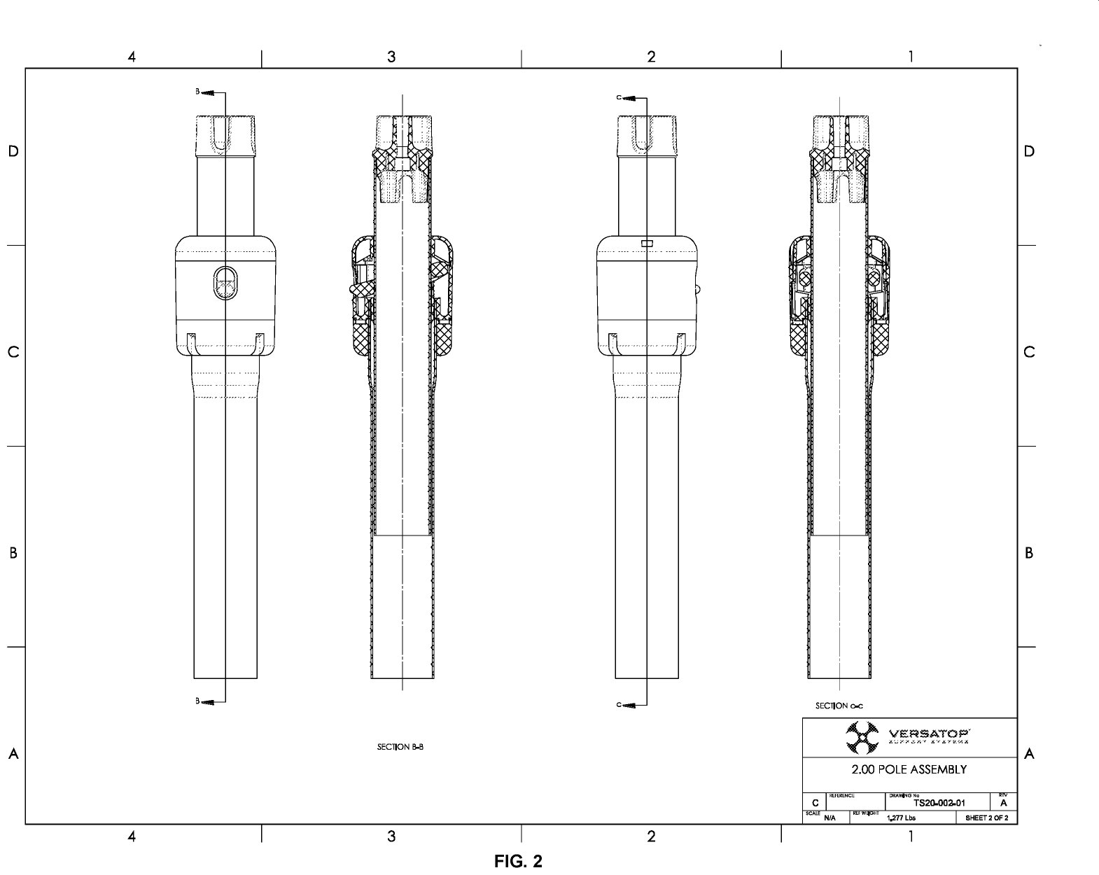

FIG. 3 shows the expanded tubing of the pole assembly in an isometric view and two side views.

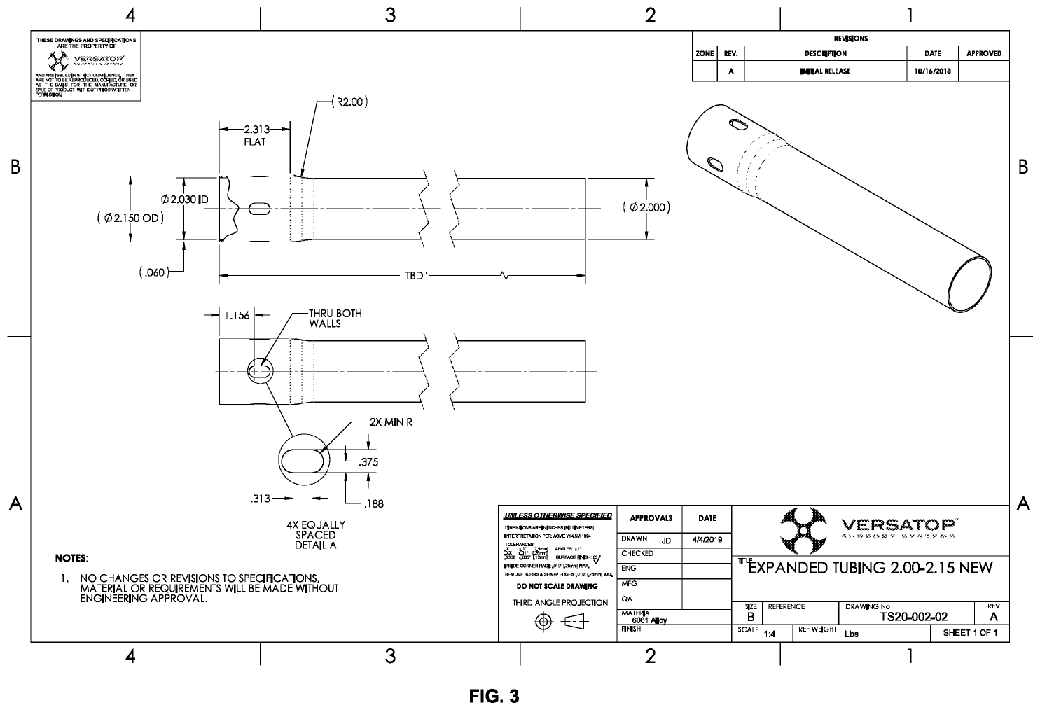

FIG. 4 shows the lower support cap of the system in an isometric view, a side sectional view, a side view, and two top views.

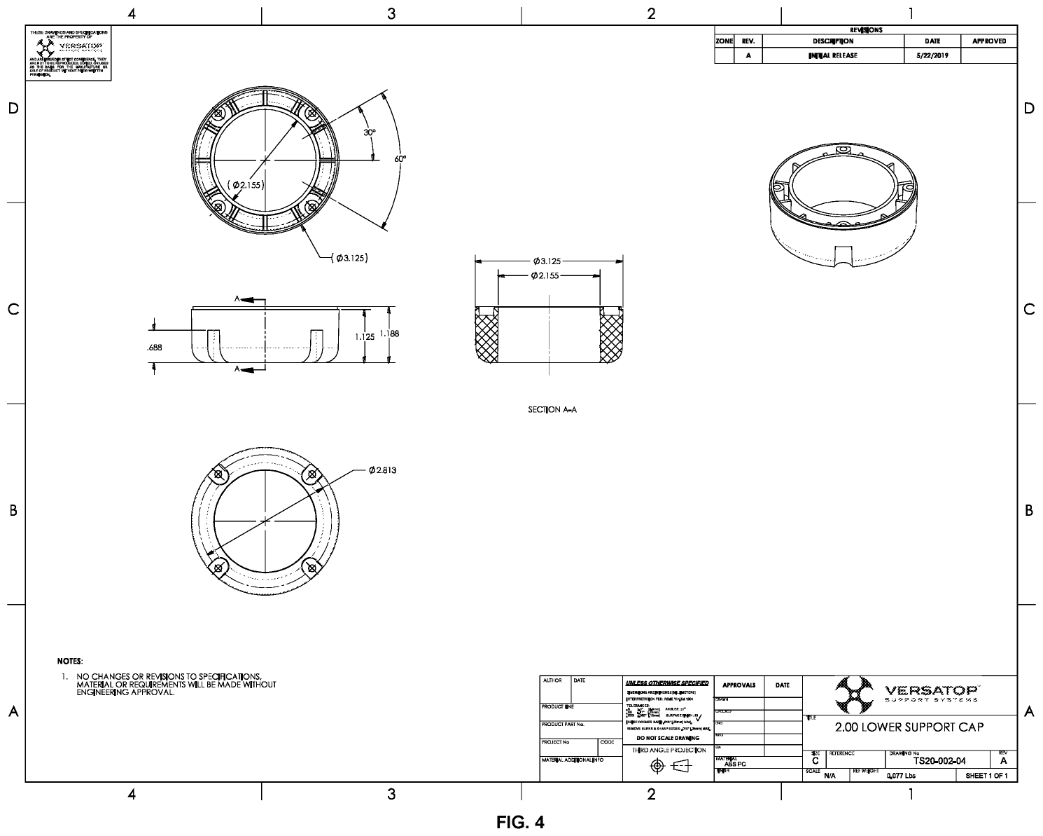

FIG. 5 shows the clamping ring of the system in an isometric view, a side sectional view, a side view and a top view.

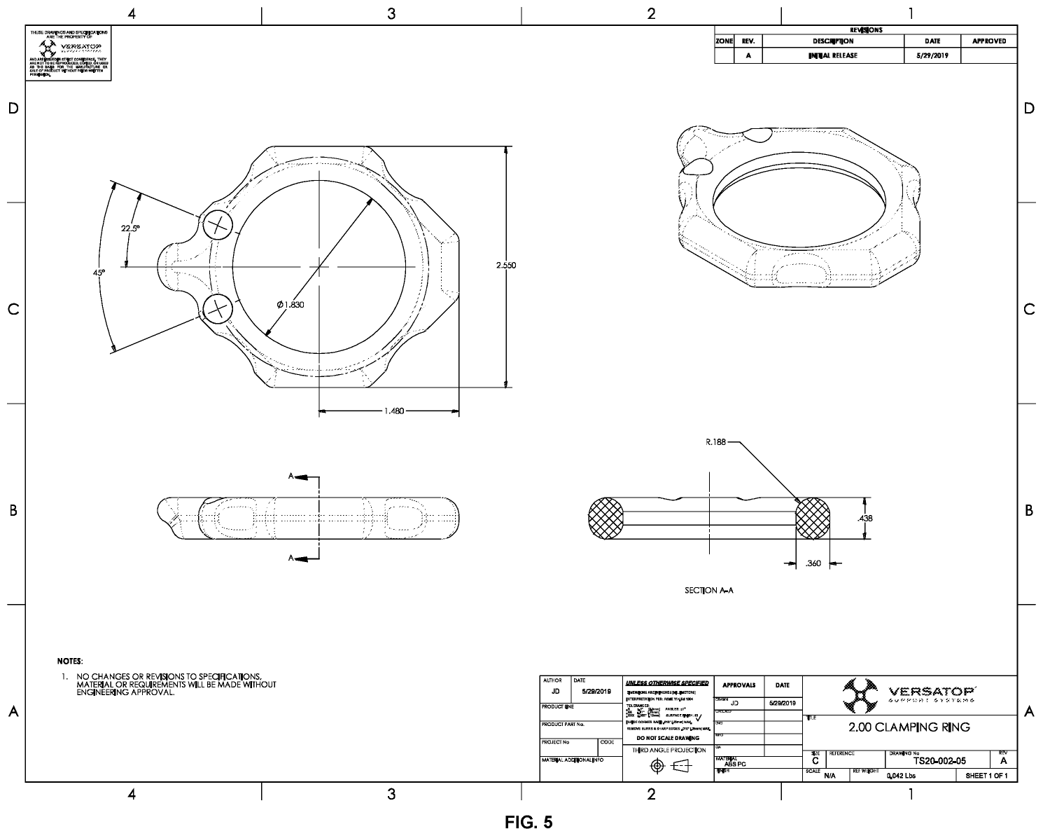

FIG. 6 shows the mid support body of the system in an isometric view, a side sectional view, a side view and two top views.

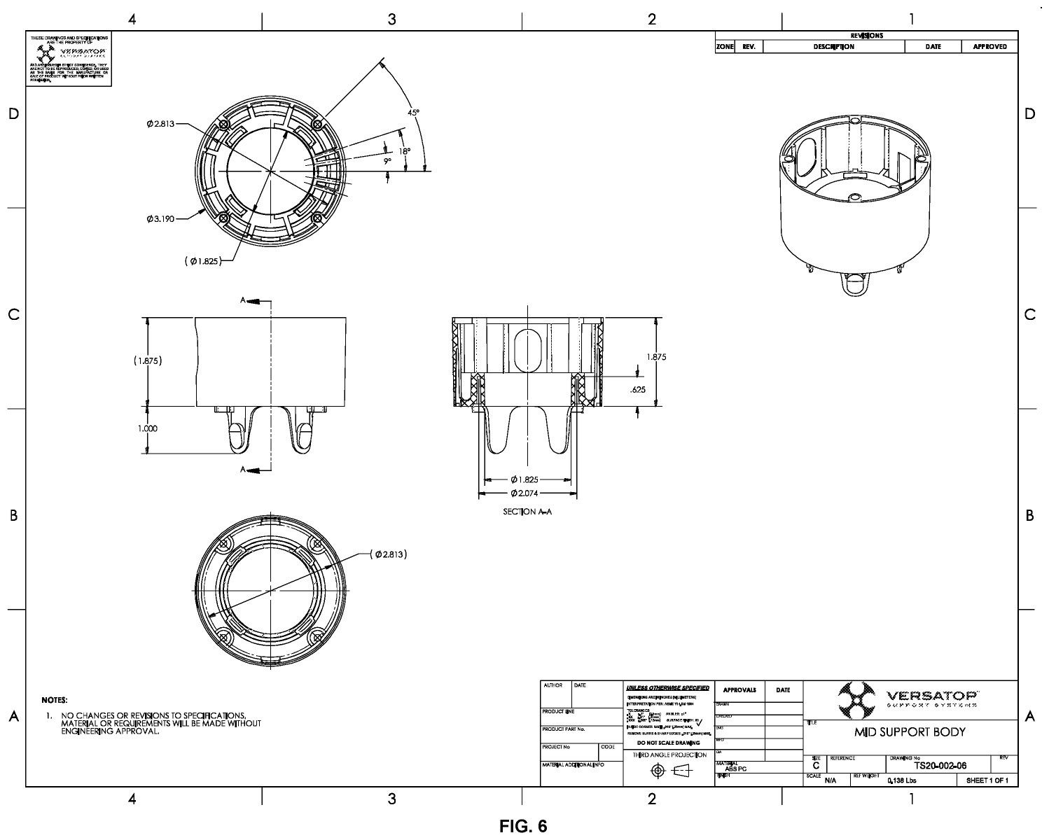

FIG. 7 shows the upper support cap of the system in an isometric view, a side sectional view, a side view and a top view.

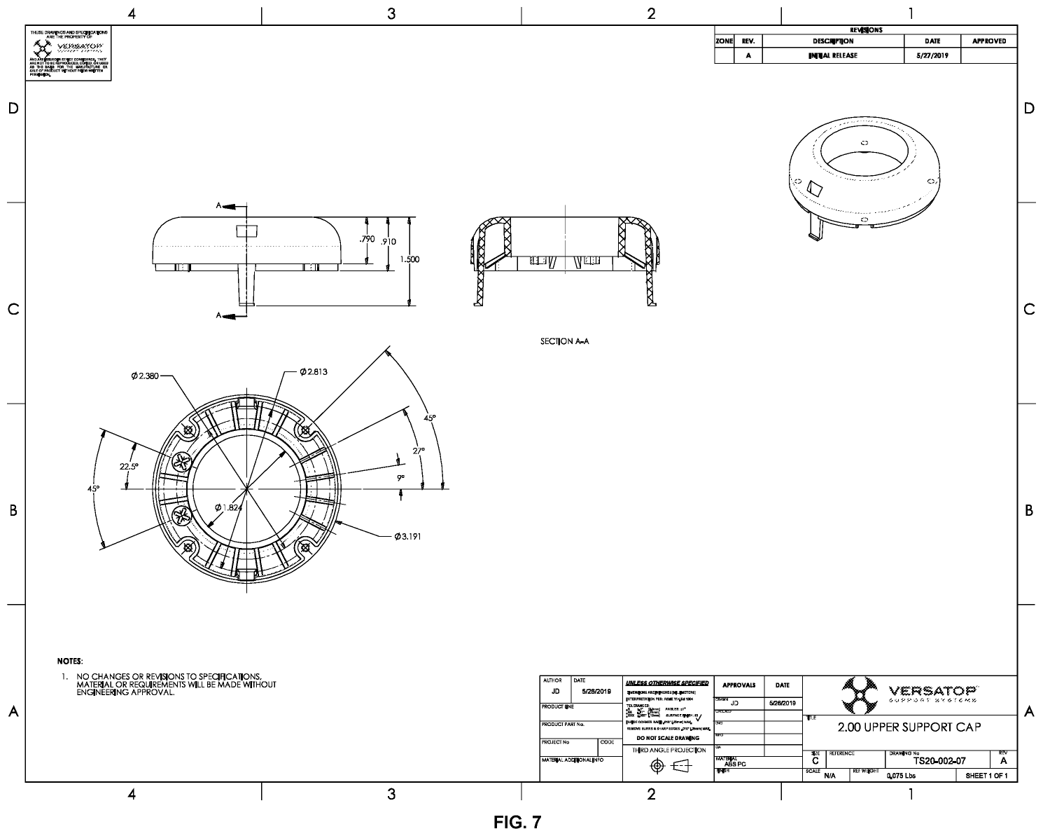

FIG. 8 shows the upper support cap assembly of the system in an isometric view, a side sectional view, a side view and a top view.

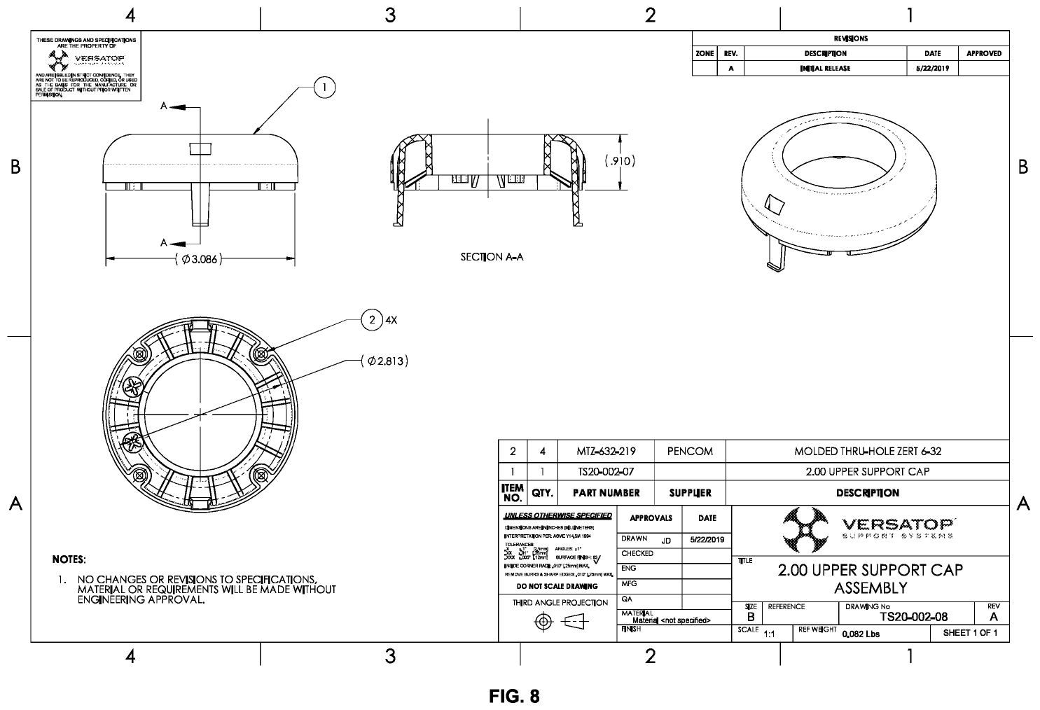

### DESCRIPTION

The system of the invention includes a vertically adjustable telescoping pole assembly and cramp brake mechanism. The telescoping pole assembly includes at least an outer pole and an inner pole, and the assembly is movable bi-directionally between a closed position and an extended position. The cramp brake mechanism has a body that is secured to the outer pole of the pole assembly, and also includes a brake that releases while the pole assembly is moved to the extended position and engages when the assembly is not being moved.

As noted above, the cramp brake mechanism is fixed to an outer tube of a telescoping tube assembly in a manner that firmly secures the body, or housing, of the mechanism to the tube. The system does not use fasteners that would interfere with the motion of the nested, telescoping tubes.

In addition, the housing itself must not interfere with the motion of the nested tubes while allowing the nested tubes a maximum allowable diameter. The outer diameter of the housing is sized so that an average human hand may comfortably hold it securely. The system achieves the desired sizing of the housing by extending the housing in a direction toward the outer tube, in the form of “inner tabs” and an outer “sleeve” that captures one end of the outer tube to a distance approximately ⅓ the total length of the housing. At least one end of the outer tube is expanded to a diameter equal to the diameter of the space between the inner tabs and sleeve of the cramp lock housing. Four slots are formed, each at 90 degrees, and equal in size and shape to the “buttons” molded in the tabs of the housing.

The tabs are equal or less in thickness to the dimensional difference between the nominal tube diameter and the expanded tube diameter. This allows the inner tube to ride smoothly within the outer tube without interference while allowing a maximum diameter of the inner tube, which reduces the pivotal movement of the inner tube. Unlike the system of the invention, conventional cramp-style locking mechanisms require a large diameter for the cramp lock to operate with the required leverage being applied, and require a reduced diameter of the inner tube to allow for the mechanism to be fitted to the outer tube.

The entire housing and brake are constructed of a suitable composite nylon material. This allows for a lightweight yet robust housing and a non-marring brake. Conventional cramp-brake mechanisms require the use of a metallic base for the cramping brake, which causes wear and marring of the inner tube.

The housing of the cramp-lock mechanism includes the following three components:
(a) a central body;
(b) a top cap; and
(c) a lower sleeve.

The three components are suitably secured together with fasteners, such as four screws, which sandwich them securely together.

Within the housing a cramping “ring” is placed between the top cap and the central body and rests loosely upon a “ramp” that locates the ring in an angled position which is its locked or cramped position. The ring is held in the cramped position with two springs that are affixed to the ring and the underside of the top cap using molded pins (top cap) and divots (ring). The ring extends through an opening at the side of the central body to allow user to move the ring to an un-cramped angle, thus unlocking the inner tube.

Users can control the linear motion of the inner telescoping tube by the amount of “lift” that is applied to the ring. The springs that hold the ring in the cramped position give positive feedback to the user as they apply force against the spring load.

The system allows the tubes to be inverted without affecting the locking action of the cramp ring. This allows the telescoping vertical tubes to be extended and collapsed entirely from the ground level.

Conventional approaches require the inner tubes to be extended and collapsed in sequence starting from the inner most tube. The starting collapsed height of the entire conventional product usually requires the user to use a ladder to reach the inner most tube. Using the system of the invention, the outer most tube is the first in the extension sequence, and is at a low enough height that the user can reach it while standing, and then can extend the telescoping tube assembly.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claim(s) and their legal equivalence.

What is claimed:

1. A system with a vertically adjustable telescoping pole assembly and cramp brake mechanism, comprising:
a telescoping pole assembly, that includes at least an outer pole and an inner pole, and that is movable bi-directionally between a closed position and an extended position; and
a cramp brake mechanism with a body that is secured to the outer pole of the pole assembly, and with a brake that releases while the pole assembly is moved to the extended position and engages when the assembly is not being moved.
